(19) United States
(12) Patent Application Publication
(10) Pub. No.: US 2011/0198319 A1
(43) Pub. Date: Aug. 18, 2011

(54) Method And Apparatus For Welding-Type Power With Real Time Clock

(75) Inventor: Bruce A. Casner, Neenah, WI (US)

(73) Assignee: Illinois Tool Works Inc., Glenview, IL (US)

(21) Appl. No.: 12/895,984

(22) Filed: Oct. 1, 2010

Related U.S. Application Data
(60) Provisional application No. 61/303,700, filed on Feb. 12, 2010.

(51) Int. Cl. B23K 11/00

(52) U.S. Cl. 219/78.01; 219/117.1

(57) ABSTRACT

A method and apparatus for providing welding-type power is disclosed and includes an RTC module and/or a non-volatile memory.

### FIELD OF THE INVENTION

The present invention relates generally to the art of welding-type power supplies. More specifically, it relates to a welding-type power supply with a real-time and/or network enabled clock.

### BACKGROUND OF THE INVENTION

There are many known welding-type systems used to provide a welding-type output or welding-type power for many known applications. Welding-type system, as used herein, includes any device capable of supplying welding, plasma cutting, and/or induction heating power including choppers, resonant power supplies, quasi-resonant power supplies, inverters, converters, etc., as well as control circuitry and other ancillary circuitry associated therewith. Welding-type output, as used herein, includes outputs suitable for welding, plasma or heating. Welding type power, as used herein, refers to welding, plasma or heating power.

Examples of prior art welding-type systems include those described in Method of Designing and Manufacturing Welding-Type Power Supplies, Albrecht, filed Sep. 19, 2001, application Ser. No. 09/956,401, which issued on Mar. 30, 2004 as U.S. Pat. No. 6,713,721; Pendant Control for a Welding-Type System, L. Thomas Hayes, filed Sep. 19, 2001, application Ser. No. 09/956,502, which issued on Oct. 28, 2003 as U.S. Pat. No. 6,639,182; Welding-Type Power Supply With A State-Based Controller, Holverson et al, filed Sep. 19, 2001, application Ser. No. 09/956,548, which issued on Jun. 8, 2004 as U.S. Pat. No. 6,747,247; Welding-Type System With Network And Multiple Level Messaging Between Components, Davidson et al., filed Sep. 19, 2001, application Ser. No. 09/957,707, which issued on Dec. 30, 2003 as U.S. Pat. No. 6,670,579; Welding-Type Power Supply With Boot Loader, L. Thomas Hayes, filed Sep. 19, 2001, application Ser. No. 09/956,405, which issued on Jan. 7, 2003 as U.S. Pat. No. 6,504,131; and Welding-Type System With Robot Calibration, Rappl et al., filed Sep. 19, 2001, application Ser. No. 09/956,501, which issued on Nov. 4, 2003 as U.S. Pat. No. 6,642,482. Each of these patents is hereby incorporated by reference.

Some such systems include network capability, where the welding-type system is connected through an ethernet, devicenet, or other type of network to external systems. This may be particularly true for advanced systems and/or robotic systems.

If such welding-type systems are designed to monitor and log weld data, it is desirable to be able to include a real time information with the data monitored and/or logged. Such time information could be used to troubleshoot, identify improper welds, determine productivity of specific processes or users, etc. Accordingly, a welding-type system that includes a real time clock is desired.

### SUMMARY OF THE PRESENT INVENTION

According to a first aspect of the invention a welding-type system includes a real time clock. The clock preferably includes a battery back-up to insure that the clock keeps time when the system is not powered up, or while it is powering up.

According to a second aspect of the invention a welding-type system includes a real time clock that has a network interface and is capable of updating the time over a network, such as using NTP over the internet. A battery may be included to insure the clock maintains the correct time when power is down, and than the system periodically checks the time via NTP and the internet to correct the time (if needed). Alternatively, the clock may use NTP and the internet to establish a time at power-up, so that even if a battery back-up fails or is not provided, the proper time is established before welding.

Other principal features and advantages of the invention will become apparent to those skilled in the art upon review of the following drawings, the detailed description and the appended claims.

### BRIEF DESCRIPTION OF THE DRAWINGS

FIG. 1 is a welding-type system in accordance with the preferred embodiment of the present invention; and

FIG. 2 is block diagram in accordance with the preferred embodiment of the present invention

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding-type system it should be understood at the outset that the real time clock can also be implemented with other welding-type systems.

The preferred embodiment provides for implementing the invention with the Miller Axcess® welding power supply. The Axcess® is modified to have weld data logging and/or monitoring in the preferred embodiment, such as shown in the attached appendix. A real time clock module is included in the welding-type system and is used to time-tag (or time stamp) some or all of the information monitored and/or logged. Module, as used herein, includes software and/or hardware that cooperates to perform one or more tasks, and can include digital commands, control circuitry, power circuitry, networking hardware, etc.

The RTC (Real Time Clock) module preferably includes a battery to maintain time through power cycling of the machine. One alternative provides that the RTC is set over a wired or wireless network using NTP (Network Time Protocol) and an NTP server. The NTP server can be located locally and accessed through a local network such as a company's intranet, or located remotely, and accessed via the internet (or other wide area network).

The RTC module preferably includes a commercially available RTC chip. the RTC chip and battery backup is preferably included in a module that stays with the machine through board repair and replacement of major functional pieces. The RTC module also preferably includes non-volatile memory which is preserved with the machine for storage of serial numbers and similar data. Alternatives includes the RTC module being part of an off-the-shelf micro controller, and/or custom made, and/or the memory receiving the time tag from the RTC module, but not being part of the RTC module.

The RTC module provides for time tagging logged data and weld monitoring data. This allows the owner of the welding-type system to track monitored or logged information by shift and operator, correlate logs from robots and other machinery in the welding cell, and correlate of other information from the manufacturing process. The included memory allows preserving desired machine specific data for the life of the machine, through power cycling and replacement of main boards.

One alternative provides for the welding-type system to be networked to a computer with an OS (Operating System) and to use NTP to synchronize the RTC with the OS time. Another alternative provides for the welding-type system to be connected to the internet (or other WAN) and for the RTC module to use NTP to access a WAN time server.

Yet another alternative provides for saving the time tagged data and/or machine specific date in non-volatile storage that is not part of the RTC module, such as a USB flash drive, memory stick, etc.

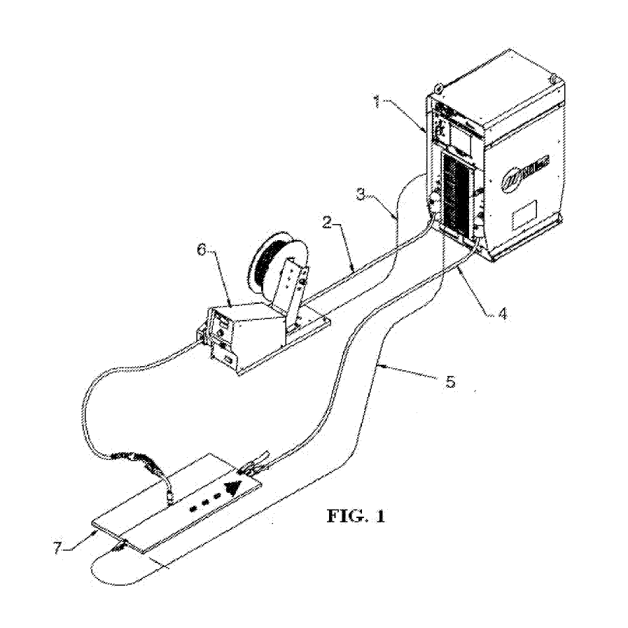

Referring to FIG. 1, a welding-type system 100 includes a power supply 1, and a wire feeder 6, which cooperate to provide power over a pair of weld cables 2 and 4 to a workpiece 7. Feeder cable 3 and a voltage sense cable 5 are used for control/feedback. The system shown is an Axcess® welding system, but the invention may readily be implemented with other welding-type systems.

Welding system 100 performs generally as prior art welding systems, but includes an RTC module to time stamp data logged or monitored by system 100. Also, in accordance with one embodiment, system 100 includes a non-volatile memory, such as a removable USB flash drive.

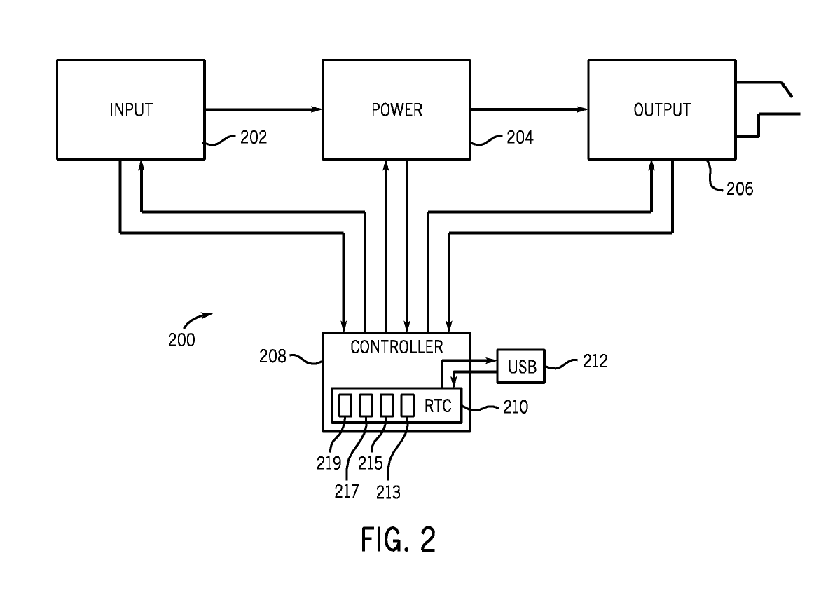

Referring now to FIG. 2, a diagram shows a welding-type system 200 includes an input circuit 202, a power circuit 204, and an output 206, as well as a controller 208. Circuits 202, 204 and 206, and controller 208, are part of welding power supply 1 (FIG. 1) in the preferred embodiment. They are distributed over several locations (such as wire feeder 6, an external control circuit, etc.) in other embodiments. Circuits 202, 204 and 206, and controller 208 are functional blocks and need not be physically distinct circuits.

Circuits 202, 204 and 206, are, in one embodiment, consistent with those shown in U.S. Pat. No. 6,329,636, entitled Method And Apparatus For Receiving A Universal Input Voltage In A Welding, Plasma Or Heating Power Source, issued Dec. 11, 2001, which is hereby incorporated by reference. Accordingly, circuits 202, 204 and 206 may include circuitry to rectify, boost, power factor correct, invert and transform different input powers into welding-type power.

Controller 208 includes much of the control circuitry of the prior art, including that used to turn switches on and off circuits 202, 204 and 206. This switch control circuitry can be implemented with other control circuitry, including digital, analog, and include micro processors, DSPs, analog circuitry, etc. Also, controller 208 preferably includes circuitry to monitor and/or log operating date.

In accordance with the invention an RTC module 210 is used to time tag data collected, stored, and/or monitored by controller 208 (or data handled by circuitry external to controller 208). RTC module 210 is preferably a commercially available RTC chip with a battery backup 213. Other alternatives include 210 being an off-the-shelf micro controller with an RTC built into it, or a custom made RTC circuit.

Data that is time tagged preferably includes one or more of data from a shift or operator, logs from robots and other machinery in the welding cell, information from the manufacturing process, machine specific data, data used to troubleshoot, identify improper welds, determine productivity of specific processes or users, etc.

A non-volatile memory 212 is preferably a USB port for use with a USB flash drive, memory stick, external hard drive, etc. USB memory 212 can be used to store the logged and time stamped data. Alternatively, the time tagged data can be sent over a network, wired or wireless through a network interface 215. Network interface 215 is a wired network interface in one embodiment and a wireless network interface in another embodiment. RTC module 210 can use network interface 215 with NTP software 217 to update the clock over the network.

In operation data from one or more of circuits 202, 204, 206 and other sources such as robots, pendant, wire feeders, users, etc is monitored and/or logged by controller 208. Some or all of this data is time tagged by RTC module 210. Preferably, the data is then stored on USB memory 212. The data can be used to determine productivity, needed maintenance, etc. Alternatives include providing a non-volatile memory 219 within RTC module 210.

Various alternatives provide that welding-type system 100 includes network communication, such as WAN, LAN, over power lines, over a smart grid, and that the data transmitted and/or stored, such as on a usb drive, include arc parameters and primary information, such as harmonics data, utilization data, etc. The information can be shared over the network or using a drive with end users, power companies, manufacturers that use welders, manufactures that supply welders, etc. Additionally, various alternatives and arrangements are shown in the attached appendix.

Numerous modifications may be made to the present invention which still fall within the intended scope hereof. Thus, it should be apparent that there has been provided in accordance with the present invention a method and apparatus for a welding-type system with a RTC and/or a non-volatile memory that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A welding-type system including a real time clock module.

2. The welding-type system of claim 1, wherein the real time clock module includes a battery.

3. The welding-type system of claim 1, wherein the real time clock module includes a network interface.

4. The welding-type system of claim 3, wherein the real time clock module includes software for implementing an NTP over the network interface.

5. The welding-type system of claim 3, wherein the network interface is one of a wireless network interface and a wired network interface.

6. The welding-type system of claim 3, wherein the real time clock module is part of a micro controller.

7. The welding-type system of claim 3, wherein the real time clock module includes non-volatile memory.

8. The welding-type system of claim 3, wherein the non-volatile memory stores one or more of logged data, weld monitoring data, and machine specific data.

9. The welding-type system of claim 3, wherein the network interface is networkable to at least one of a computer with an OS, the internet, a smart grid and power lines.

10. The welding-type system of claim 2, further comprising non-volatile memory that is not part of the real time clock module.

11. The welding-type system of claim 10, wherein the non-volatile memory that is at least one of a USB flash drive and a memory stick.

12. A method of tracking data in a welding-type system, comprising:
providing a real time clock within the welding system;
obtaining welding-type system data;
time tagging the welding-type system data using the time from the real time clock; and
storing the time tagged data in non-volatile memory.

13. The method of claim 12, further comprising, providing a battery back-up to the real time clock and keeping time with the real time clock when the system is not powered up.

14. The method of claim 12, further comprising updating the time kept by the real time clock over a network.

15. The method of claim 12, wherein time tagging welding-type system data includes time tagging at least one of weld data, data from a shift, data from an operator, logs from robots, logs from peripherals, machine specific data, arc parameters, primary power harmonics data, primary power utilization data and data used to identify improper welds.

16. The method of claim 12, further comprising accessing the time tagged over a network external of the welding-type system.

17. The method of claim 12, further comprising accessing the time tagged over at least one of an ethernet, power lines, a smart grid,
